(19) United States
(12) Patent Application Publication
(10) Pub. No.: US 2018/0349813 A1
(43) Pub. Date: Dec. 6, 2018

(54) Mobile App to Allow for Instant and Real-Time Integration of Geology, Petrophysics, Reservoir Engineering, Production Technology, Petroleum Engineering, Production Engineering, and Process Engineering Disciplines on a Single Interface by an Individual to Display Oil Field Production Data and Information and to Conduct Oil Field Production Surveillance and Optimization Using a Mobile Device

(71) Applicant: Subhayu Basu, Houston, TX (US)

(72) Inventor: Subhayu Basu, Houston, TX (US)

(21) Appl. No.: 15/613,236

(22) Filed: Jun. 4, 2017

(51) Int. Cl. G06Q 10/06; G06Q 50/02; E21B 41/00; G06F 3/0484; G06F 3/0485

(52) U.S. Cl. CPC G06Q 10/0633; G06Q 50/02; G06F 3/0485; G06F 3/04847; E21B 41/00

(57) ABSTRACT

A mobile app is developed to seamlessly integrate oil field production data and information coming from geology and engineering disciplines to conduct fully integrated surface and subsurface evaluation of well and reservoir performance with a single application software for optimising daily production and maximising recovery factor in real time. The mobile app would also allow for 3D visualization of static and dynamic models on mobile devices which would allow for field engineers instant, real-time, and seamless understanding of subsurface status of the oil producing wells that would not only enable prompt and accurate decision making process but also assist in simplifying the process by ease of access to all stakeholders.

The mobile app would permit real-time integration across disciplines on a single interface to instantly process and analyze data and information in order to clearly evaluate on-going field production and identify challenges. It would represent a seamless production surveillance and optimization tool that would instantly integrate and display relevant field production data and subsurface information, which is invaluable to top level management, engineers, and field personnel during decision making process.

This application claims priority to and the benefit of the filing date of U.S. Provisional Application No. 62/500,787 filed on May 3, 2017, entitled “A MOBILE APP TO ALLOW FOR INSTANT AND REAL-TIME INTEGRATION OF GEOLOGY, PETROPHYSICS, RESERVOIR ENGINEERING, PRODUCTION TECHNOLOGY, PETROLEUM ENGINEERING, PRODUCTION ENGINEERING, AND PROCESS ENGINEERING DISCIPLINES TO CONDUCT OIL FIELD PRODUCTION OPTIMIZATION”, which is hereby incorporated by reference in its entirety.

### FIELD OF THE INVENTION

The invention relates to creation of mobile app for conducting oil production surveillance and optimization work through the integration of seven (7) disciplines within geology and engineering areas. More particularly, the mobile app would enable oil production surveillance and optimization tasks to be carried out on a single interface and in real-time from anywhere in the world as the data and information becomes available from the seven (7) disciplines.

### BACKGROUND OF THE INVENTION

Several applications in oil and gas industry are used for the monitoring of oil field surveillance and oil production optimization. This is necessitated by the need to integrate data and information from seven (7) disciplines—geology, petrophysics, reservoir engineering, production technology, petroleum engineering, production engineering, and process engineering—to identify and evaluate the challenges encountered in oil production system and thereby support decision making process.

The integration between diverse disciplines is difficult and inefficient because the data and information from different disciplines requires processing by several different application software that are specialized in one or few specific areas. Furthermore, the applications coming from different vendors rarely talk to one another making it difficult to review the totality of the data and subsequently interpret and analyze the data for extracting relevant information.

As a result, engineers and field operators are dependent on several applications and interfaces that must be opened and managed to evaluate the oil field production status and identify challenges in the production system.

Furthermore, since all application software in exploration and production area of the oil and gas industry are computer-based, it becomes even more cumbersome and inconvenient to carry out integrated analysis of the data and information acquired from the seven (7) disciplines. This is caused primarily due to lack of portability of the computers and associated application software making it difficult to bring to bear relevant personnel and resources for seeking resolution to problems and challenges in the production system in a timely manner.

As a result, the current work flow to conduct production surveillance and optimization tasks poses the risk of generating significant uncertainty and errors in outcome of the analysis and interpretation.

On many occasions the decision process gets either postponed or delayed indefinitely because of unwieldy nature of bringing personnel and resources from several or all seven (7) disciplines in front of a computer to evaluate in-coming data and information.

### SUMMARY OF THE INVENTION

To circumvent the challenges of disparate applications to process data and information from seven (7) different disciplines, the app is developed to integrate the interpretation and analysis of in-coming oil production data and information from diverse disciplines to be carried out on a single interface in real time on mobile devices, which would allow for ease of access to data and information and the added convenience of conducting production surveillance and optimisation task from anywhere in the world.

The app would greatly enhance the speed and facilitation of the decision-making process, which would occur in an accurate, effective, and timely manner without compromising the quality of the outcome of data interpretation and analysis.

The app would provide instant, real-time access to production data and information and simultaneously analyse them utilizing one application software to assist in carrying out production surveillance and optimisation activities that would include but not limited to integrated well and reservoir analysis, flow assurance, production system debottlenecking, and subsurface evaluation on mobile devices.

### DETAILED DESCRIPTION OF THE INVENTION

The mobile app would represent a seamless oil production surveillance and oil production optimization tool for senior management, engineers, and field operators to assist in knowing the production status, in analyzing performance of wells, in evaluating subsurface oil reserves, and in carrying out daily tasks associated with oil production optimization activity through real-time integration and analysis of data and information across the seven (7) disciplines.

All tasks are conducted on a single interface using one application software installed on a mobile device for ease of access, convenience, and mobility.

The features and capabilities of the mobile app are presented in following paragraphs. It is pointed out that the functionalities of the app allow for the production surveillance and optimization tasks to be carried out through integrated interpretation and analysis of data and information from seven (7) disciplines in real-time on mobile devices.

The app displays and plots daily, weekly, monthly, and yearly production and injection data at well, reservoir, field, block, and corporate level including provision of daily field and well production reports.

The app presents comparison of year-to-date performance with business plan at well, reservoir, field, block, and corporate level.

The app features 2D visualization of production and pressure data at all nodes in the production system that includes wells, platforms, pipeline network, and flow gathering systems to assist in identifying source of increase or decrease in production, back pressures, and bottlenecks in the system.

The app features visualization of platform topsides displaying slots and wells with associated production summary.

The app displays and plots daily, weekly monthly, and yearly production and pressures for all well head and production platforms.

The app advises optimal operating parameters such as choke size, gas lift rate, and casing head pressure with changing tubing pressure, liquid rate, gas oil ratio, and water cut.

The app evaluates and plots all well test data for all wells.

The app displays Hall Plot analyses.

The app updates well models for all producers and injectors.

The app updates material balance models for all producing reservoirs.

The app updates integrated reservoir, well, pipelines, and facilities model for the entire production system.

The app presents outcome of well production data analyses to assess its current performance in relation to its optimum capacity.

The app enables extracting and displaying production forecast profiles at well, reservoir, field, block, and corporate level.

The app features well test data analysis and validation for all wells.

The app estimates productivity index for all producers and injectors.

The app presents comparison of production and well test data between selected wells.

The app conducts sensitivity analysis of well performance with respect to tubing head pressure, gas lift rate, reservoir pressure, gas oil ratio, and water cut.

The app provides the ability to quality control production and associated data being entered in the corporate database.

The app displays reservoir pressure history and current reservoir pressure.

The app displays remaining reserves at well, reservoir, field, block, and corporate level.

The app displays reservoir parameters and fluid properties for all reservoirs.

The app displays completion diagram, deviation survey, interpreted log, well intervention history and status, pressure-volume-temperature (PVT) report, end of well report, application to drill well report, application to complete well report, and structure maps for all wells.

The app displays and plots allocated production for all wells, reservoirs, platforms, and fields.

The app displays and plots gas lift design and performance curve for all gas-lifted wells.

The app displays and plots daily, weekly, monthly, and yearly lift gas supply from gas compression system and gas source wells.

The app determines accuracy of gas rate measurements.

The app features monitoring and evaluation of production data wirelessly transmitted to office.

The app displays piping and instrumentation diagrams.

The app displays history matched 3D dynamic model showing completed wells, current fluid contacts, and net oil distribution.

The app displays 3D static model showing distribution of porosity, permeability, initial water saturation, and net-to-gross.

The app features visualization of well locations and associated perforations and drainhole trajectory to estimate production potential of wells based on remaining reserves at different drainage points.

The app displays cross-section across perforation for deviated wells and drainhole section for horizontal wells displaying current fluid contacts.

The app displays cross-section across perforation for deviated wells and drainhole section for horizontal wells displaying structural and geological heterogeneity.

### BRIEF DESCRIPTION OF THE DRAWINGS

The app would be installed on a mobile device. It will interact remotely with database on a server to pick data and information associated with production and subsurface asset through Wi-Fi connectivity.

Some features of the invention are illustrated as an example and are not limited by the figures of the accompanying drawings. It is pointed out that all the data and information processed and displayed by the mobile app is synchronised with the database on the server and is continuously updated in real-time.

FIG. 1 shows schematic of the interaction of the mobile devices to the database server through Wi-Fi connectivity and the requirements for data, information, and access to relevant applications for operating the mobile app.

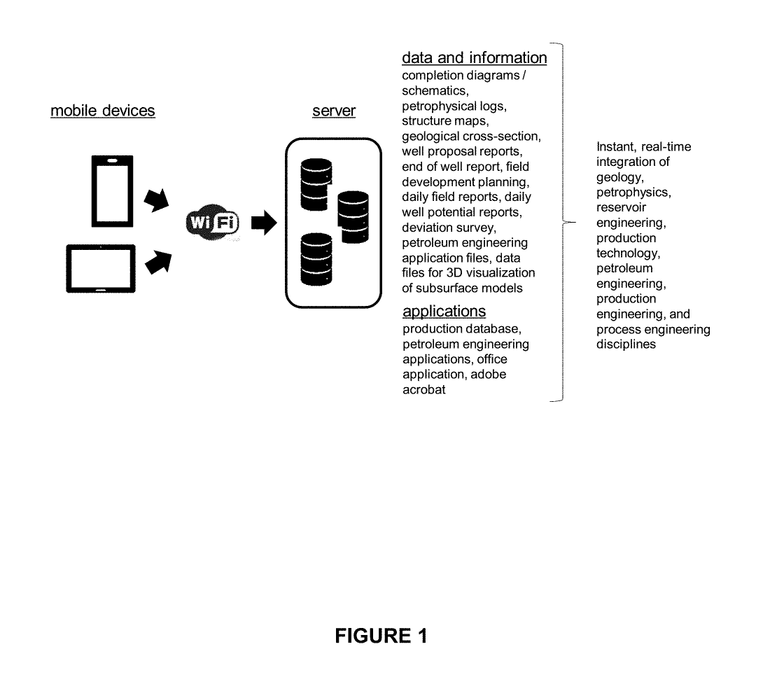

FIG. 2 displays production summary for past two (2) days for metered and ullage oil rate from three (3) producing blocks using the mobile app.

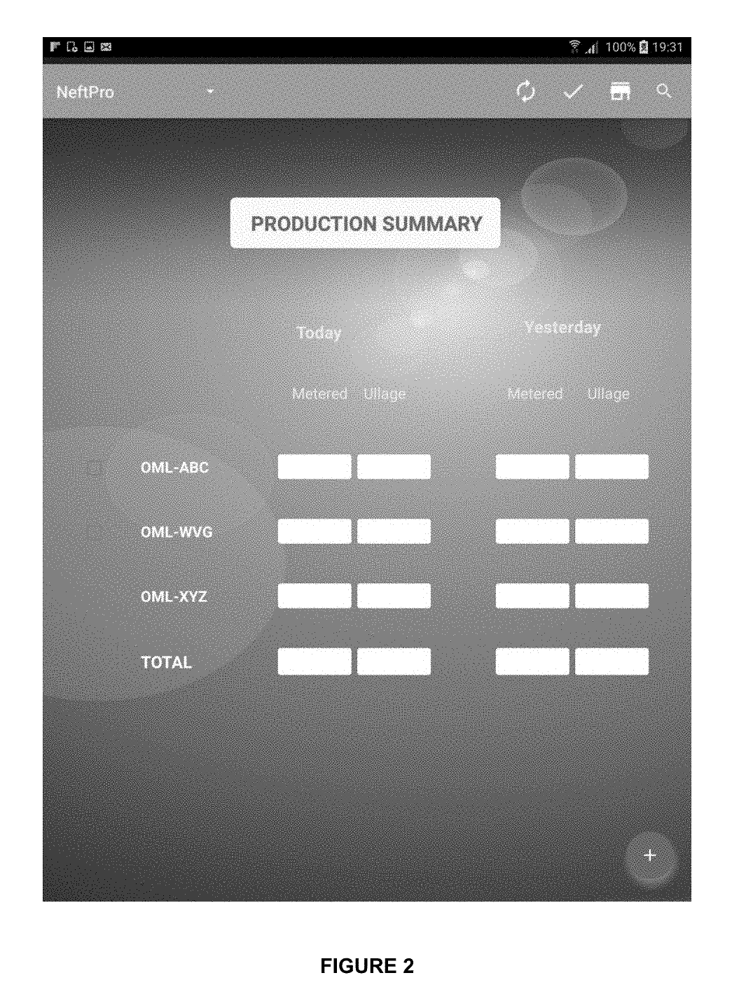

FIG. 3 displays plot of daily production of oil rate (BOPD), gas rate, water rate (BWPD), gas oil ratio (GOR), water cut (WCT), and gas lift injection rate (GAS LIFT) for a producing block using the mobile app.

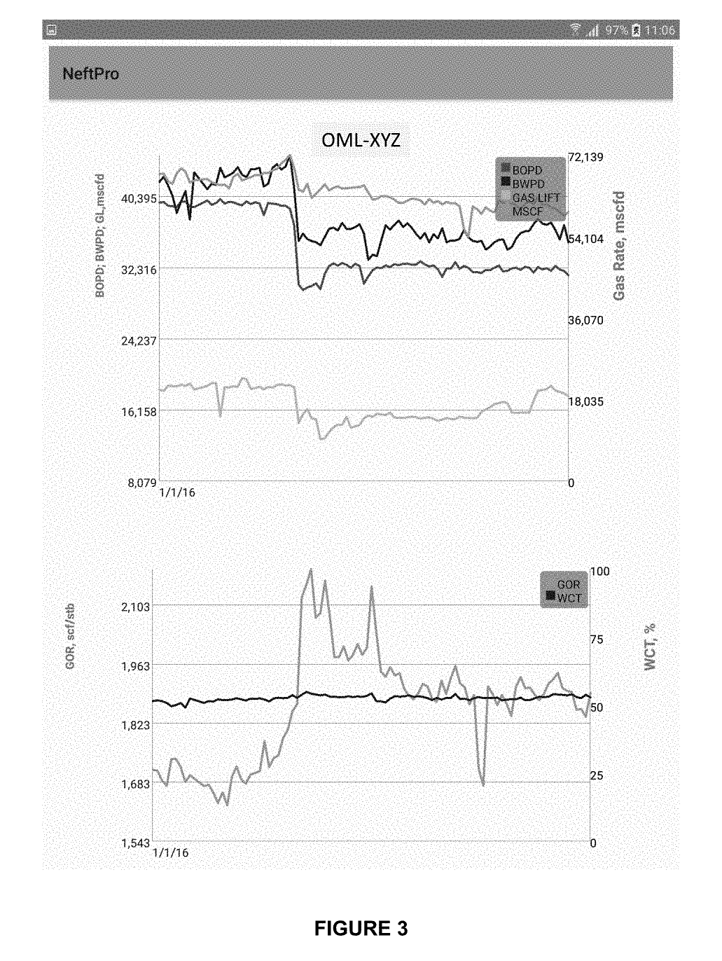

FIG. 4 displays current and past recorded well production test data including remaining 2P reserves that has been extracted from database using the mobile app.

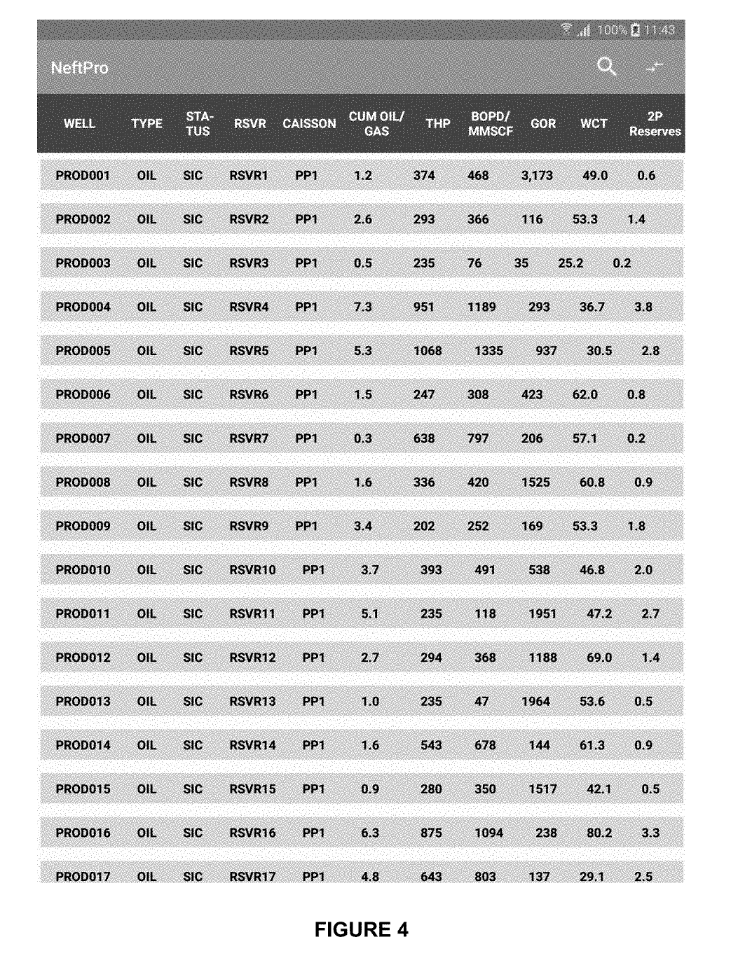

FIG. 5 illustrates the ability to filter current and past recorded well production test data based upon well name, well type, well status, reservoir and platform (caisson) using the mobile app.

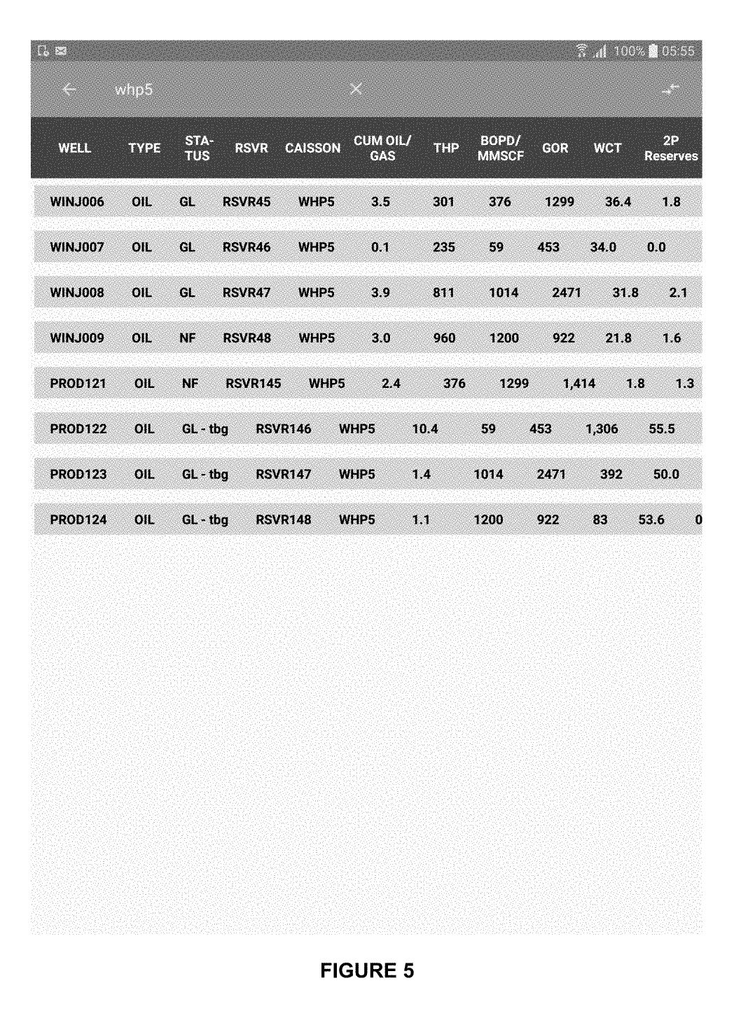

FIG. 6 displays (a) outline of well parameters and reservoir properties and (b) summarises production history and present status of the reservoir using the mobile app.

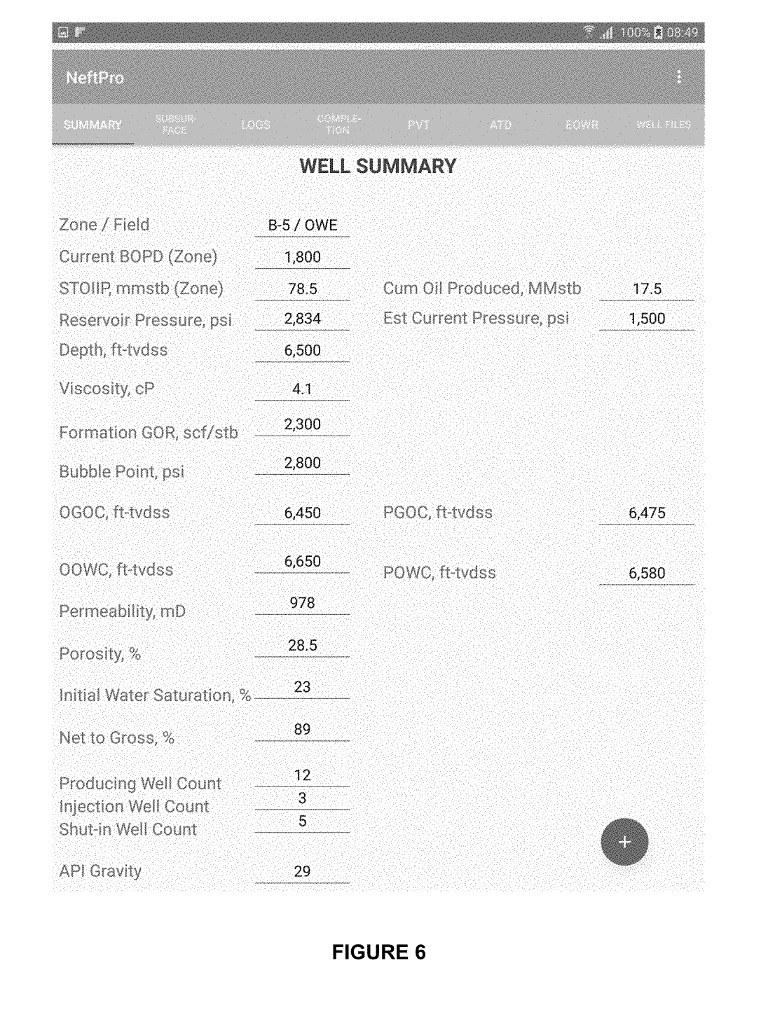

FIG. 7 shows 2D visualization of production system depicting (a) production platform (PP) and well head platforms (WHP), (b) pipelines transporting oil, water, and gas, (c) flow gathering station (FPSO), and (d) recorded arrival and departure pressure data for past two (2) days at production and well head platforms using the mobile app.

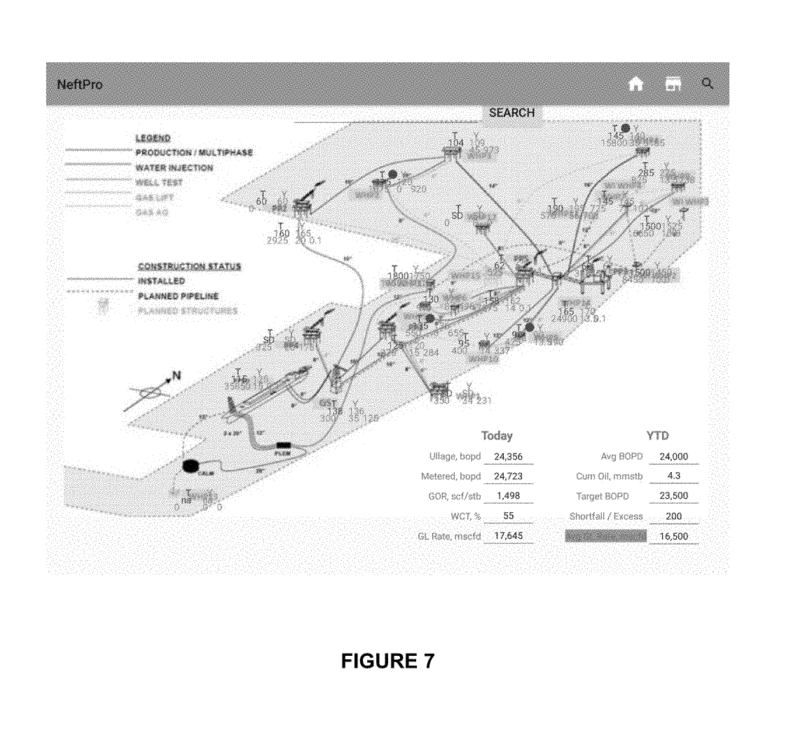

FIG. 8 shows validation of well test data conducted with well model (built in Prosper) using the mobile app.

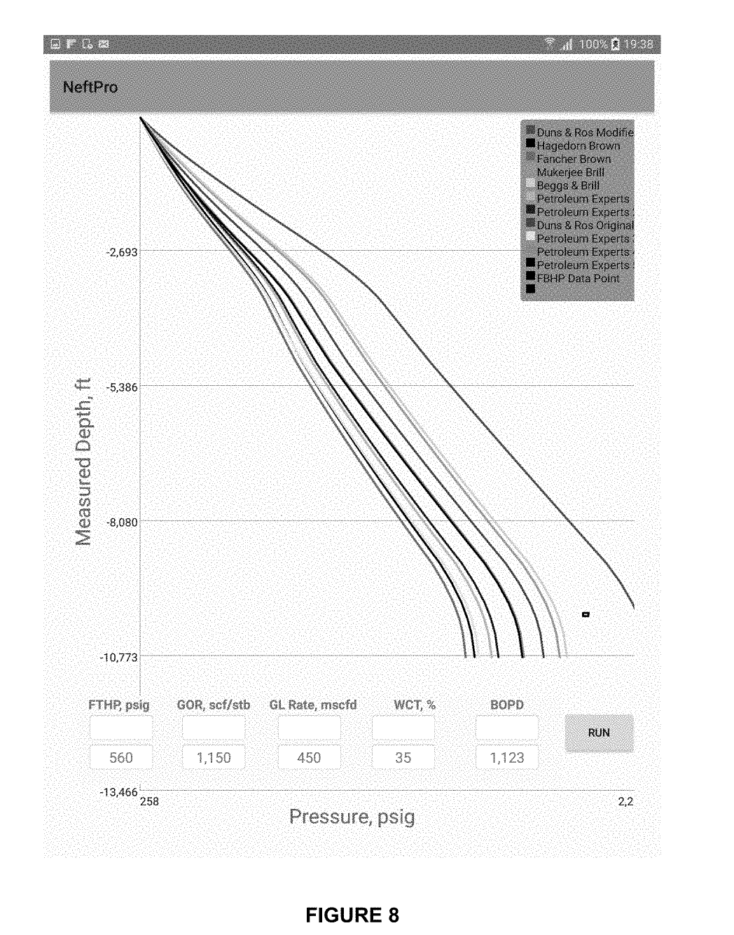

FIG. 9 shows estimation of productivity index employing well model (built in Prosper) for flowing well using the mobile app.

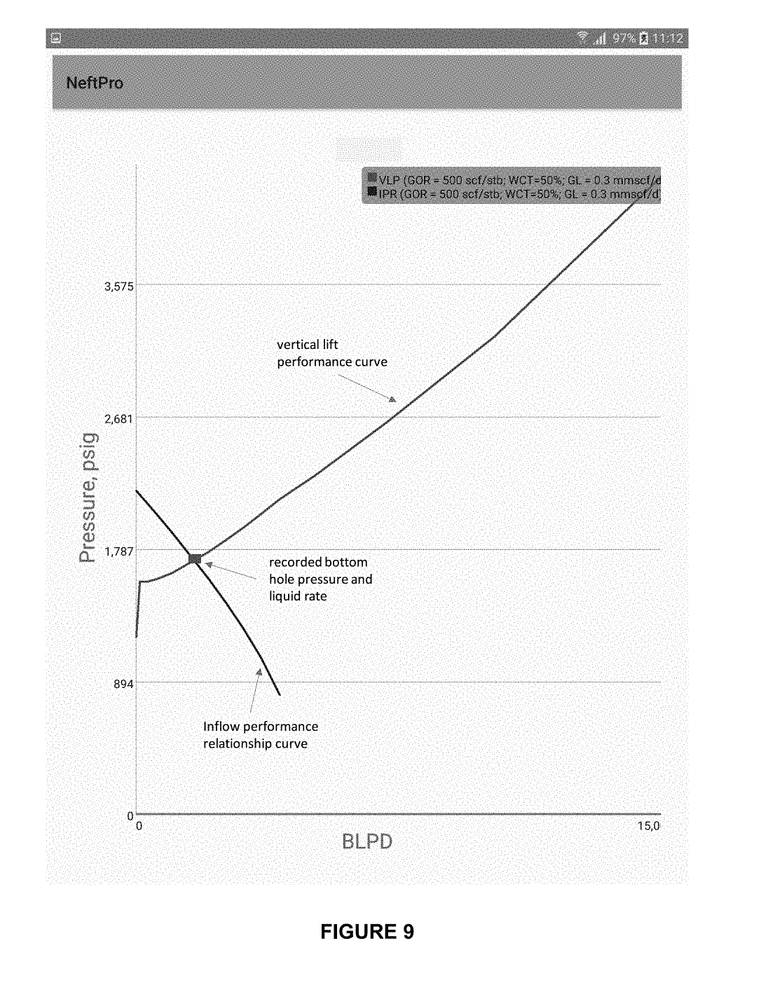

FIG. 10 shows panel to input low, medium, and high values for flowing tubing head pressure (FTHP), gas oil ratio, water cut, reservoir pressure, and gas lift injection rate (GL Rate) to conduct sensitivity analysis for determining relationship between these parameters and well performance using the mobile app.

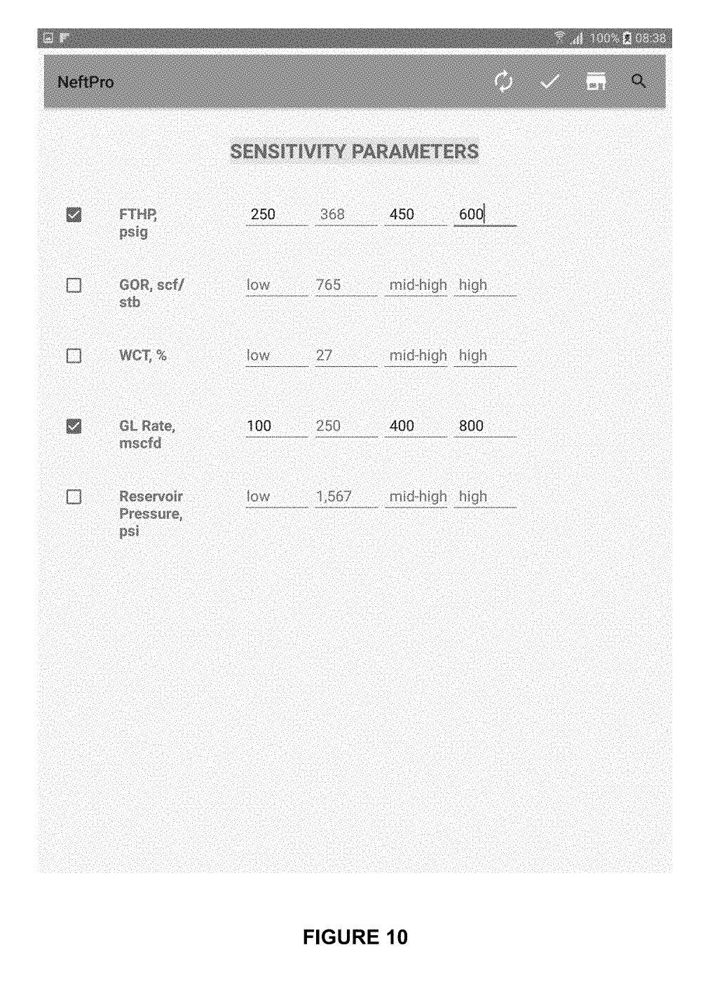

FIG. 11 shows results of sensitivity analysis carried out with gas oil ratio, water cut, and gas lift injection rate parameters employing well model (built in Prosper) using the mobile app.

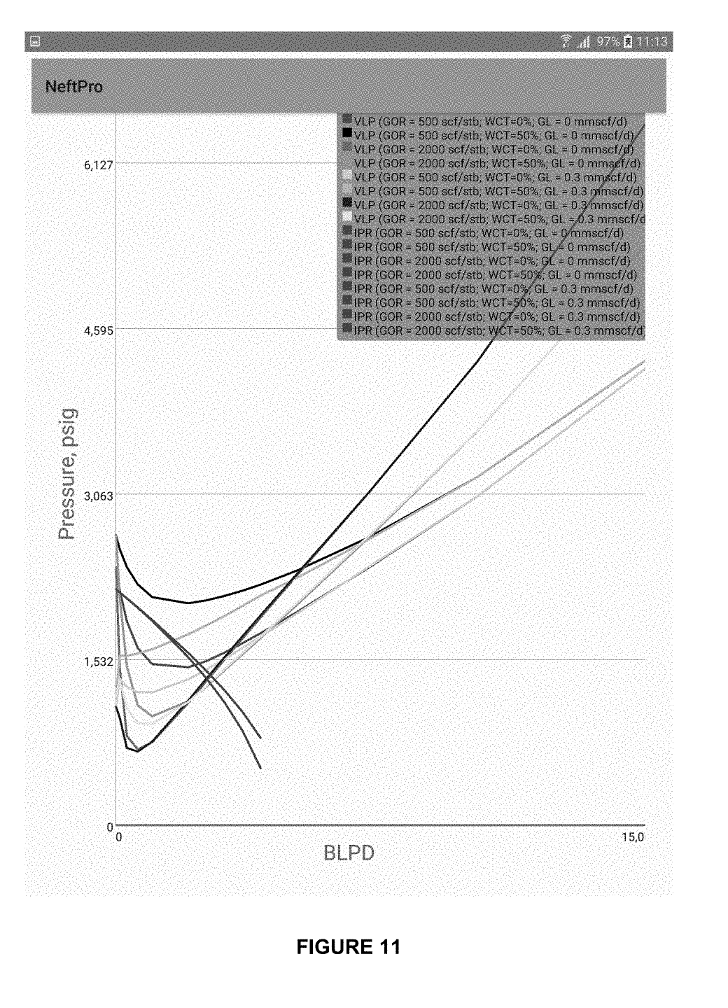

FIG. 12 shows results of parameters determined from well model (built in Prosper) using the mobile app in order for operating well at optimum producing capacity and comparison with existing well operating parameters and associated soil rate.

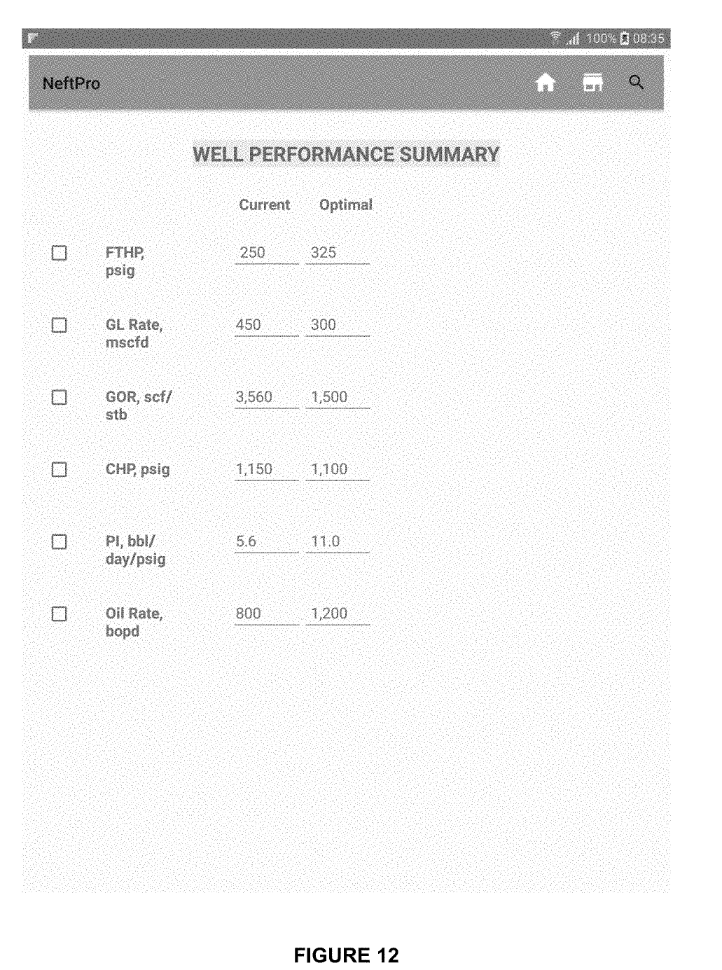

FIG. 13 illustrates completion schematics of a well using the mobile app.

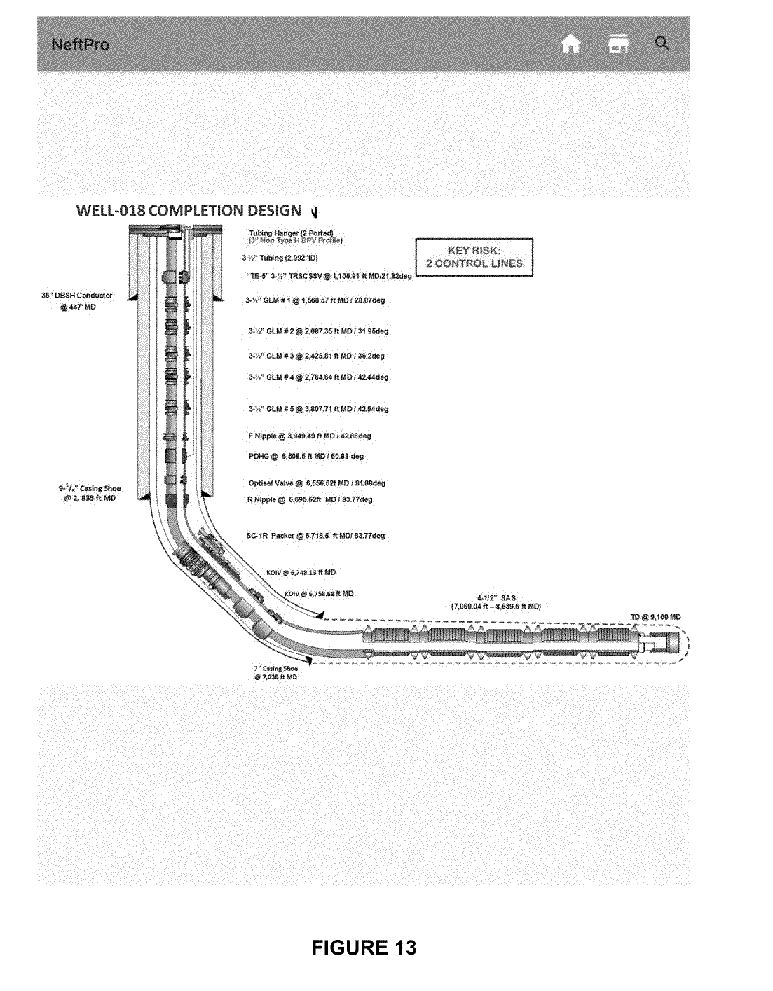

FIG. 14 presents outcome of gas lift design parameters and gas lift performance curve generated from well model (built in Prosper) using the mobile app to ensure well is subjected to optimal casing head pressure (CHP) and gas lift injection rate for maximising well performance.

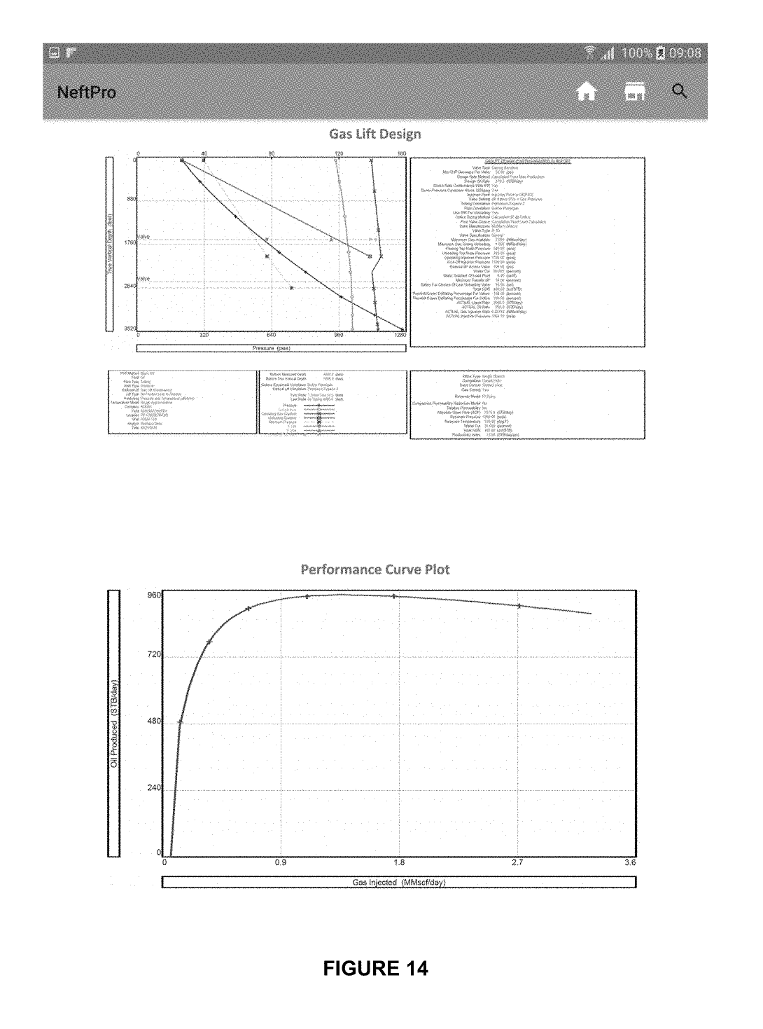

FIG. 15 displays all the well test data recorded during producing life of well using the mobile app.

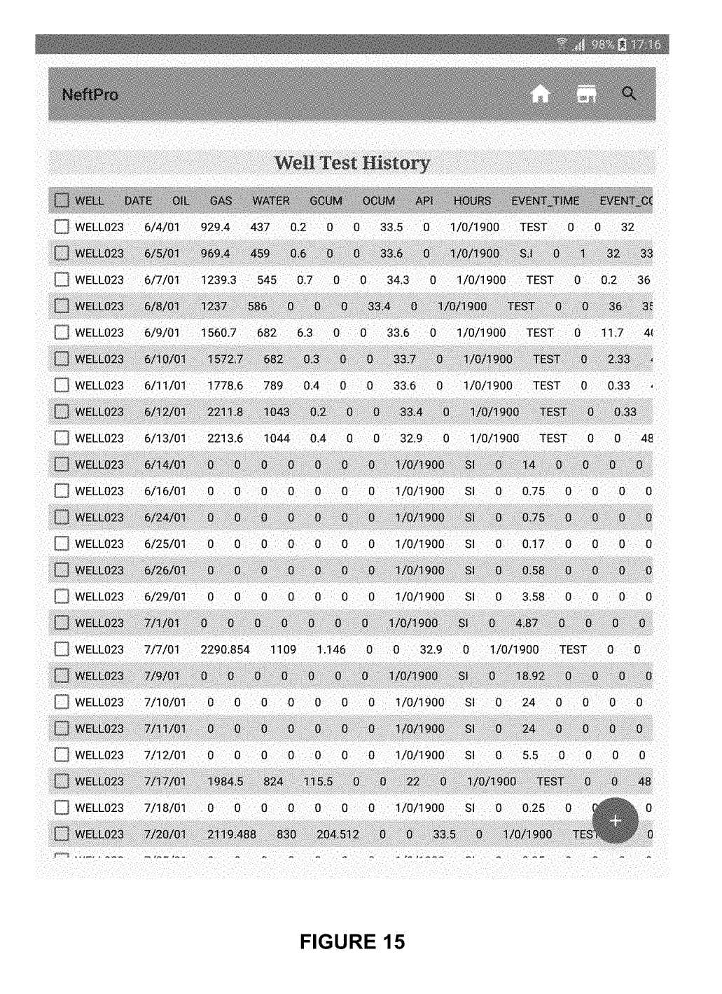

FIG. 16 presents the plot of all well test data recorded during producing life of well that includes oil rate (BOPD), liquid rate (BLPD), flowing tubing head pressure (FTHP), gas oil ratio, injected lift gas-to-liquid ratio (GLR), water cut, and choke size using the mobile app.

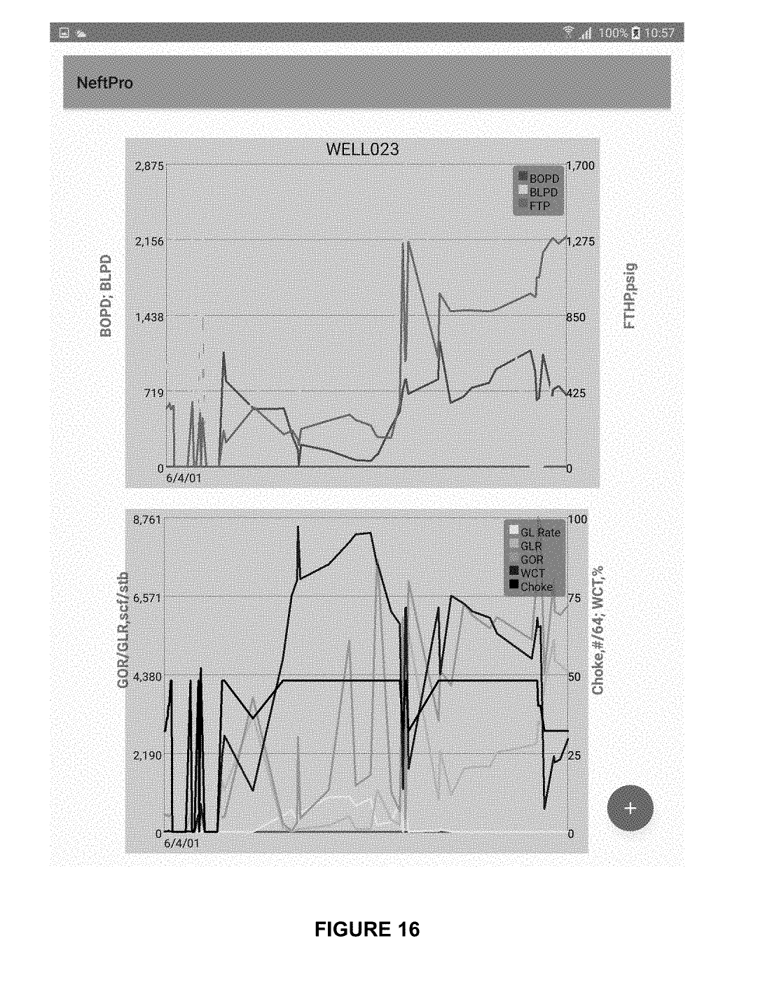

FIG. 17 displays the plot of allocated production for a well that includes oil rate, water rate, gas rate, gas-oil ratio, and water cut using the mobile app.

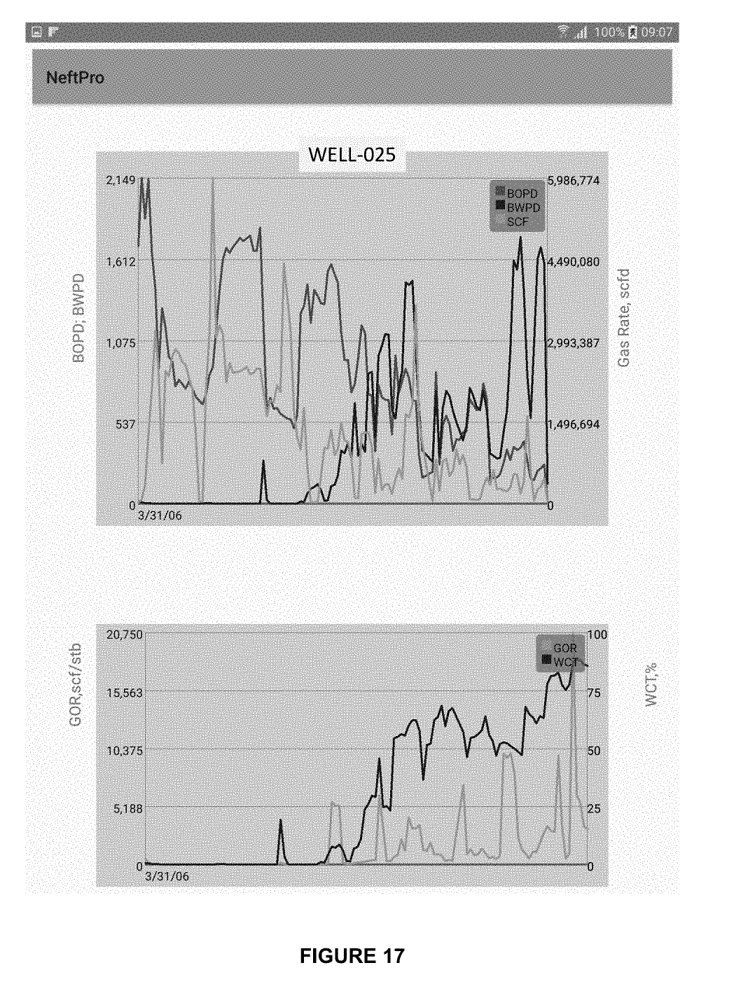

FIG. 18 illustrates the location of wells and associated production status on a platform and the expanded menu list to display and plot the arrival pressure, departure pressure, and production from the platform on weekly, monthly, and yearly basis using the mobile app.

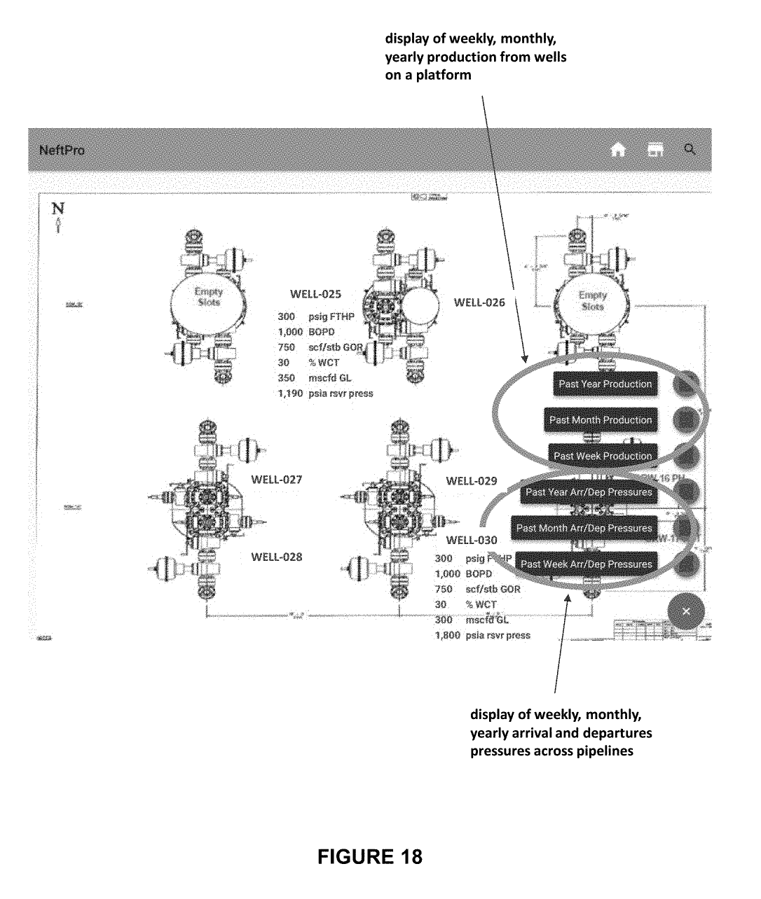

FIG. 19 displays interpreted open hole log for a producing well using the mobile app.

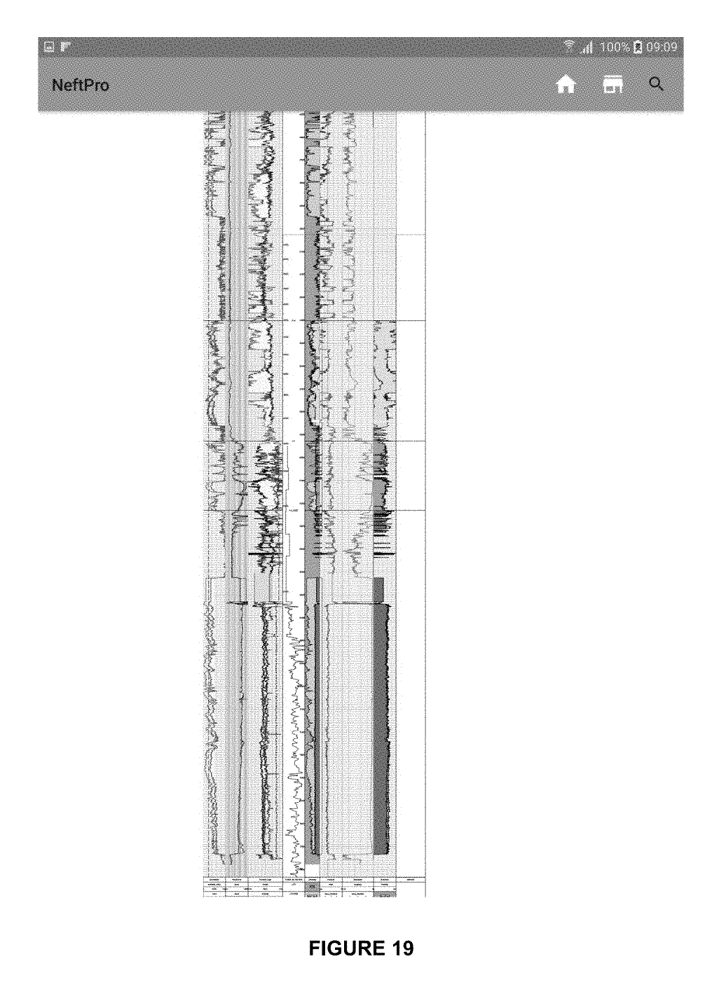

FIG. 20 presents current recovery, stock tank oil initially in place (STOIIP), and remaining reserves based upon thirty (30) percent and fifty (50) percent recovery factor (RF) for all reservoirs in a block using the mobile app.

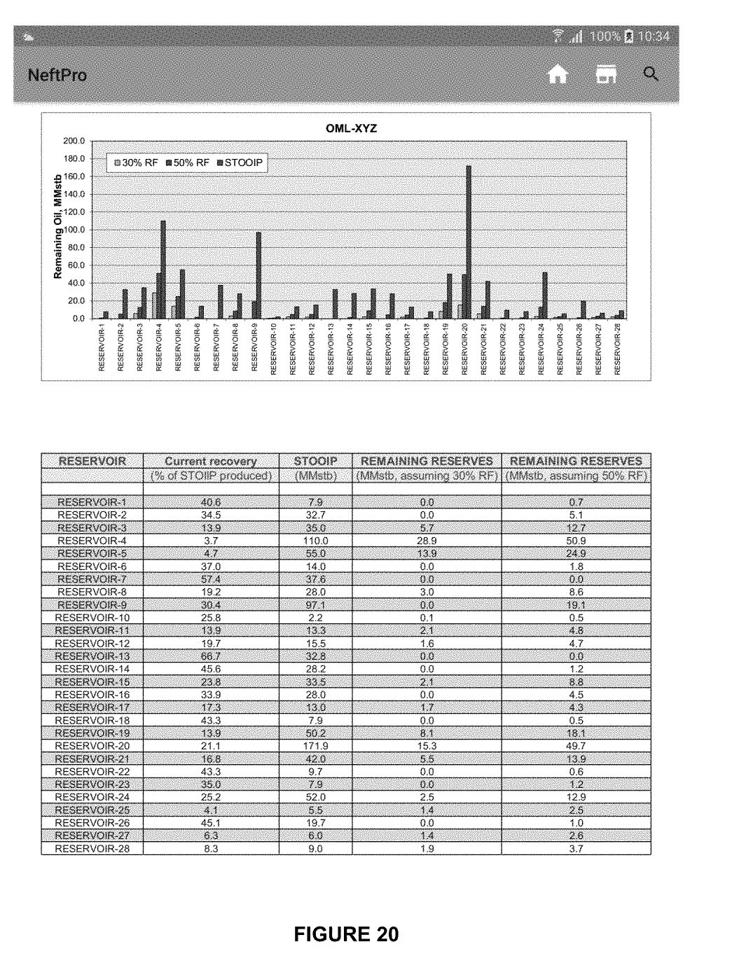

FIG. 21 presents comparison between forecasted oil rate and actual year-to-date oil rate produced using the mobile app.

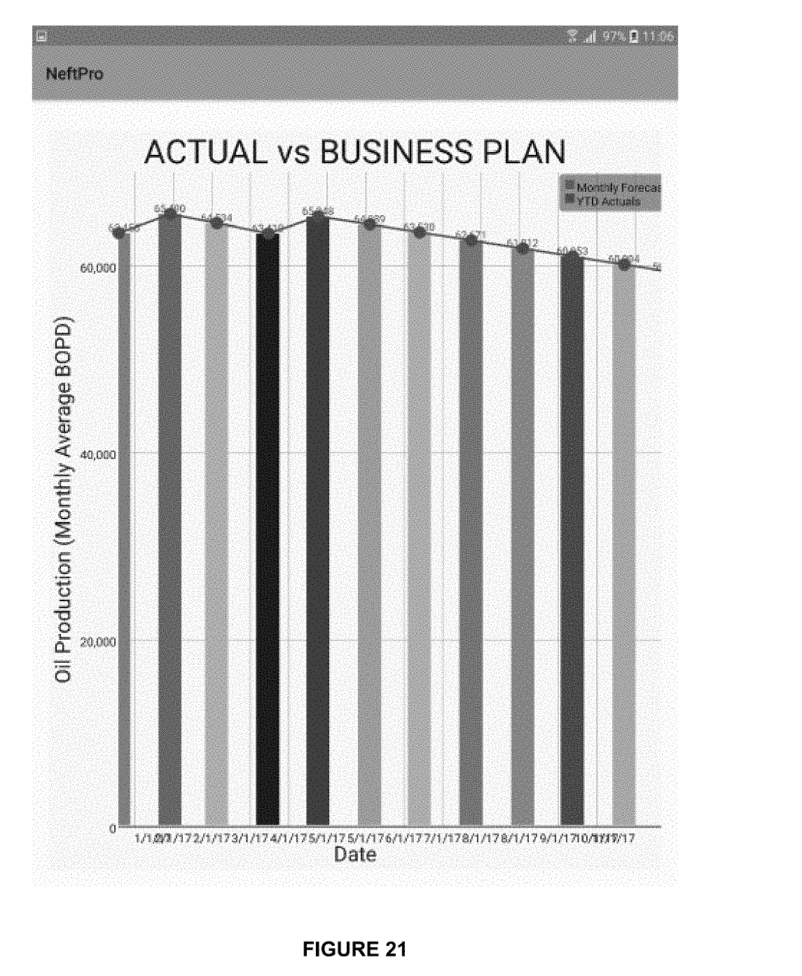

FIG. 22 displays 2D structure map and associated cross-section displaying well locations and fluid contacts using the mobile app.

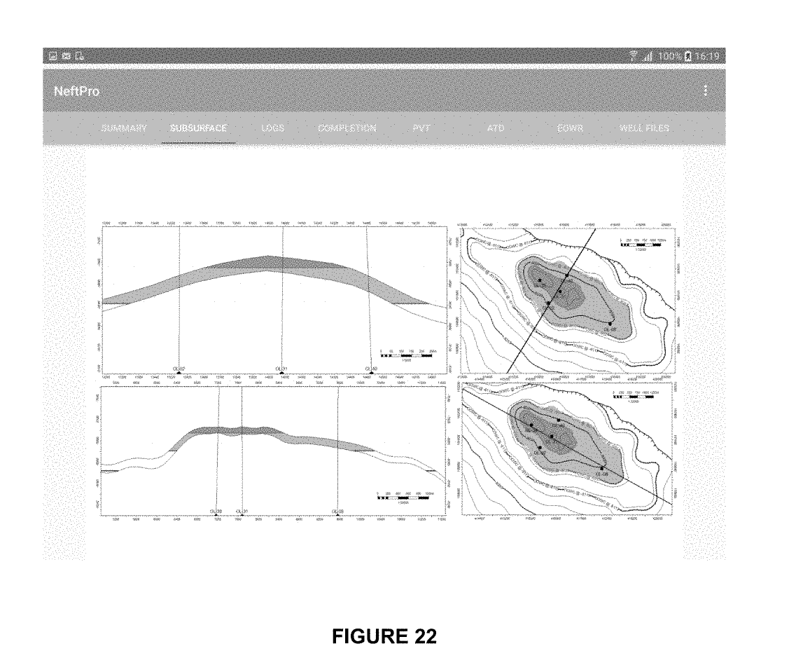

FIG. 23 displays 3D rendering of subsurface dynamic model displaying fluid contacts with well locations using the mobile app.

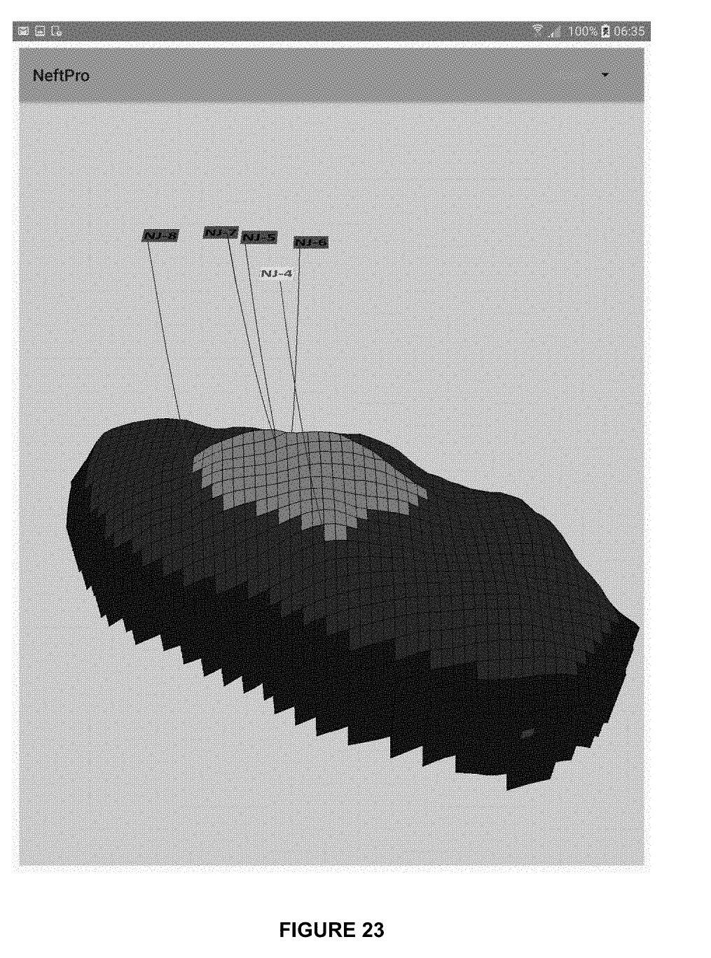

FIG. 24 displays 3D rendering of a cross-section of dynamic model with well locations using the mobile app.

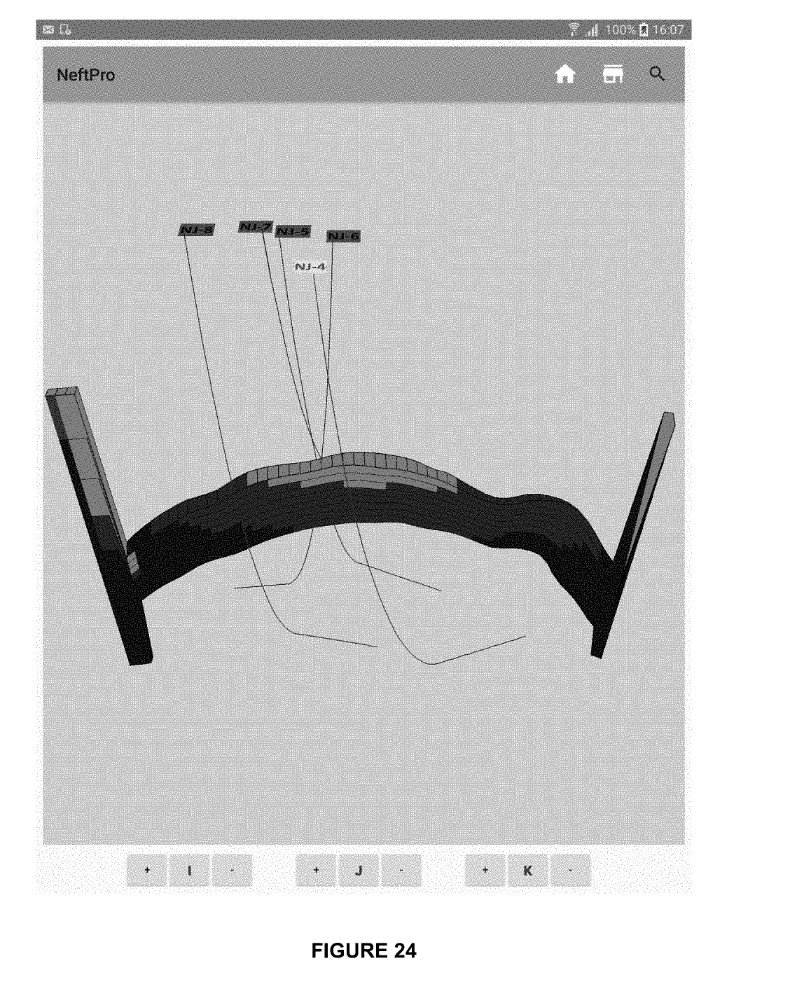

What is claimed is:

1. A mobile app for instant, real-time, and seamless integration and display of data and information related to oil field production utilizing one application software for efficiently and effectively carry out oil field surveillance and production optimization tasks by an individual using a mobile device. The tool circumvents the cumbersome workflow of opening geological, petrophysical, and engineering applications on a computer or laptop requiring both geologists and engineers in order to perform the production surveillance and optimization tasks.

2. The mobile app of claim 1 further permitting instant, real-time, and integrated evaluation and analysis of reservoir and well performance at subsurface level and of pipeline network and facilities performance at surface level on a single interface by an individual using a mobile device for optimising daily oil production and maximising recovery factor. Presently, both geologists and engineers must work with several interfaces using different software application hosted on a computer or laptop to carry out the said tasks.

3. The mobile app of claim 1 and claim 2 further allowing rendering of 3D images of subsurface structural framework, geological features, and reservoir parameters on a mobile device allowing for the engineers and field operators to assess the performance potential of a production well based upon subsurface information such as remaining recoverable oil reserves and stand-off of oil-water contact and gas-oil contact from perforation interval or horizontal section.
